(19) United States
(12) Patent Application Publication
(10) Pub. No.: US 2015/0304559 A1
(43) Pub. Date: Oct. 22, 2015

(54) MULTIPLE CAMERA PANORAMIC IMAGE CAPTURE APPARATUS

(71) Applicant: Kogeto, Inc., New York, NY (US)

(72) Inventor: Jeffrey Glasse, New York, NY (US)

(21) Appl. No.: 14/670,177

(22) Filed: Mar. 26, 2015

Related U.S. Application Data
(60) Provisional application No. 61/971,939, filed on Mar. 28, 2014.

(51) Int. Cl. H04N 5/232; H04N 5/247; H04N 5/225

(52) U.S. Cl. CPC H04N 5/23238; H04N 5/2254; H04N 5/247

(57) ABSTRACT

The present invention includes audio and video capture system that includes a plurality of video capture devices configured to capture a plurality of video streams of an event. One or more audio capture devices may additionally be configured to capture one or more audio streams of the same event. Captured image data may be stitched or otherwise combined and post capture processed to present captured image data for viewing from a desired perspective and in a desired format. Audio may be also be presented form a desired perspective and in a desired format.

### CROSS-REFERENCE TO RELATED APPLICATION

This application claims priority to and the full benefit of U.S. Provisional Patent Application Ser. No. 61/971,939, filed Mar. 28, 2014, and titled “MULTIPLE CAMERA PANORAMIC IMAGE CAPTURE APPARATUS”, the entire contents of which are incorporated herein by reference.

### TECHNICAL FIELD

This specification relates to apparatus for multiple perspective image and audio capture and playback.

### BACKGROUND

Panoramic camera systems are well known. In some systems a lens attached to a camera is fashioned to capture imagery from a wide angle. This is a straightforward approach and simple to implement, but the image quality may suffer and the extent to how wide image capture may be may be compromised.

In other systems, series of images captured in sequence are stitched together. This helps to address the limitation of how wide a wide angle lens may capture imagery, but does not offer simultaneous image capture and alignment may present additional challenges.

Still other embodiments, such as, for example, those taught in U.S. Pat. No. 7,389,181 to Meadow et al teach multiple cameras facing outwards for simultaneous capture of image data and subsequent stitching together of captured imagery into an arcuate shape or a ribbon of image data. Such systems are useful for example, in implementations requiring a moving point of image capture, such as cameras attached to a vehicle travelling down a street.

The use of optical arrangements to facilitate panoramic viewing have also been known to use a variety of configurations, including catadioptric lenses and purely refractive lenses, of various shapes and sizes. Generally, a single panoramic block is configured such that light entering it undergoes two refractions and two reflections before exiting. Both reflective surfaces are paraboloidal. in shape and achieve high quality imagery. Each of these surfaces can be replaced with a surface having a radius of the “best fit” sphere for an acceptable image quality of a still image.

However, utilization of paraboloidal reflective surfaces in combination with a telecentric exit, pupil may compromise a resulting performance of a design of an overall system rather than enhance it. Some optical configurations work better with spherical reflective surfaces as compared with paraboloidal reflective surfaces. Further, previously known systems have not addressed the use of relay optics or relay lenses for transferring intermediate images onto a camera lens. Accordingly, there is still a need for a lens or optical block that can be coupled with a camera lens, such as, for example, a camera lens included in a handheld device, such as, for example a cellular device.

Audio and image capture has also been known from a single point of capture at a single venue, such as a conference room or a classroom. Cameras and microphones may be place in a venue in order to capture an instructor or other presenter. Such events, such as a TED presentation, in turn, be broadcast live or provided as recordings for later viewing by students outside of the classroom. In such classroom applications, one camera is generally used to provide a first-person view of the instructor and/or whiteboard, and in some cases another camera is used to capture materials presented by an electronic overhead projector. Sounds are generally captured by a microphone worn by or directed toward the presenter, and in some applications additional microphones are used to pick up classroom sounds such as when a student asks a question.

### SUMMARY OF THE INVENTION

Accordingly, the present invention provides for an optical system and automated system for image data capture, up to an including three hundred and sixty (360) degree image capture. The optical system may include one or more optical lenses placed proximate to two or more image capture devices directed towards the one or more optical lenses and not towards a subject matter to be captured in the image data. The optical lenses may include one or both of: those that refract and reflect light directed into the image capture apparatus and thereby capture up to a 360-degree panoramic field of view via the two or more image capture device included within the apparatus. In some embodiments, the present invention may be used to adapt commercially available cameras (e.g., the cameras built for consumer use or into many cellular telephones) to function as panoramic image or video capture devices.

In one aspect of the present invention, a relay system following a primary component comprising a panoramic block may be functional to transfer an intermediate image, formed within a primary block on to a CCD camera to produce a real accessible image one the CCD camera.

Some implementations may include a complex relationship between various surfaces of a panoramic lens with variations of one or both of the refractive and reflective lens surface designs. Lens surfaces, either the refractive or reflective ones, may include one or more of: aspheric, an ellipsoidal surface, a paraboloidal surface, a hyperboloidal surface and an oblate spheroidal surface. In some implementations, it may be possible to achieve excellent image quality using a combination whereby two refractive surfaces and two reflective surfaces are combined in a single apparatus and are substantially spherical.

In general, the present invention includes apparatus for capturing, organizing and transmitting digital output. The digital output includes one or both of: homogenous and heterogeneous media elements together with one or more of: temporal, spatial and orientation metadata. In some embodiments, the transmitted output may provide an immersive experience.

In one aspect, an image data capture device may provide output to an automated device including a processor configured to receive, align, and associate captured image data with captured audio data. Audio and image data streams may then be transmitted across a communications network to a network access device, such as for example: a mobile phone, a tablet, a network entertainment box, or a personal computer.

In another aspect, an image data and audio data repository may be operative to store image data and audio data streams and upon command transmit the stored image data and audio data streams provide the associated video and audio streams.

The details of one or more implementations are set forth in the accompanying drawings and the description below. Other features and advantages will be apparent from the description and drawings, and from the claims.

### DESCRIPTION OF DRAWINGS

FIG. 1A illustrates a block diagram view of an exemplary multi-camera panoramic image capture apparatus.

FIG. 1B illustrates an exemplary panoramic image capture apparatus and associated image data presentation.

FIG. 2A is an exemplary panoramic image as captured through a reflective surface.

FIG. 2B is an example of a de-warped panoramic image.

FIG. 3 illustrates an example of an imaging lens.

FIG. 4 is an enlarged view of a lens.

FIG. 5 is a sectional view of an example of a lens element.

FIG. 6 is a sectional view of an example of a lens element.

FIG. 7 is a sectional view of another exemplary lens element.

FIG. 8 is an exemplary depiction of a reflective surface.

FIG. 9 is an alternative depiction of a reflective surface.

### DETAILED DESCRIPTION

The present invention provides image capture apparatus that includes an image capture devices configured with multiple cameras to capture a panoramic view of a setting. One or more audio capture devices may additionally be configured to capture one or more audio streams of the same event. Captured image data may be stitched or otherwise combined and post capture processed to present captured image data for viewing from a desired perspective and in a desired format. Audio may be also be presented form a desired perspective and in a desired format.

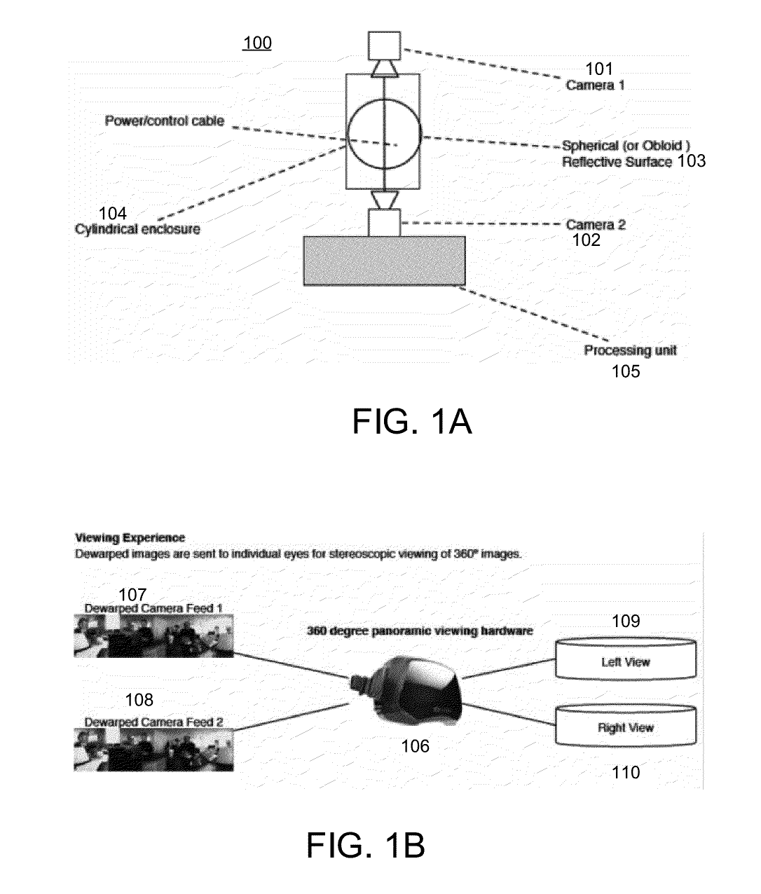

Referring now to FIG. 1A, an exemplary multi-camera image capture device 100 is illustrated. A first camera 101 and a second camera 102 are positioned to receive an image from a reflective surface 103. In some preferred embodiments, the reflective surface includes an arcuate shape surface, such as for example spherical or obloid shape. As discussed further below, other reflective surface 103 shapes are within the scope of this invention. Similarly, although a preferred embodiment of two cameras is illustrated (camera 1 and camera 2) 101-102, three or more cameras may also be used in various implementations of the present invention.

A spherical reflective surface 103 will provide image data to camera 1 101 and camera 2 102 from a panoramic perspective. As discussed further below, distortion introduced into the image data by the curved reflective surface 103. A processing unit 105 may be used to process captured image data and provide a realistic presentation of captured image data.

In another aspect, in some embodiments, a cylindrical enclosure 104 may be included to provide protection for the reflective surface 103. Wiring, such as, for example, a power cable supplying operating power to the two or more cameras 101-102 and a control supplying command signals to the two or more cameras 101-102.

Referring now to FIG. 1B, a multi camera image capture device 106 unit is illustrated with a left view 109 and a right view 110. The left view 109 and the right view 110 are imaged on a spherical reflective surface (item 103 in FIG. 1A) and captured by respective cameras (items 101 and 102 in FIG. 1A). The Captured image data is processed to present a dewarped camera feed image 1 item 107 and a dewarped camera feed image 2 108. In a similar manner, additional cameras may be utilized to provide additional camera feeds.

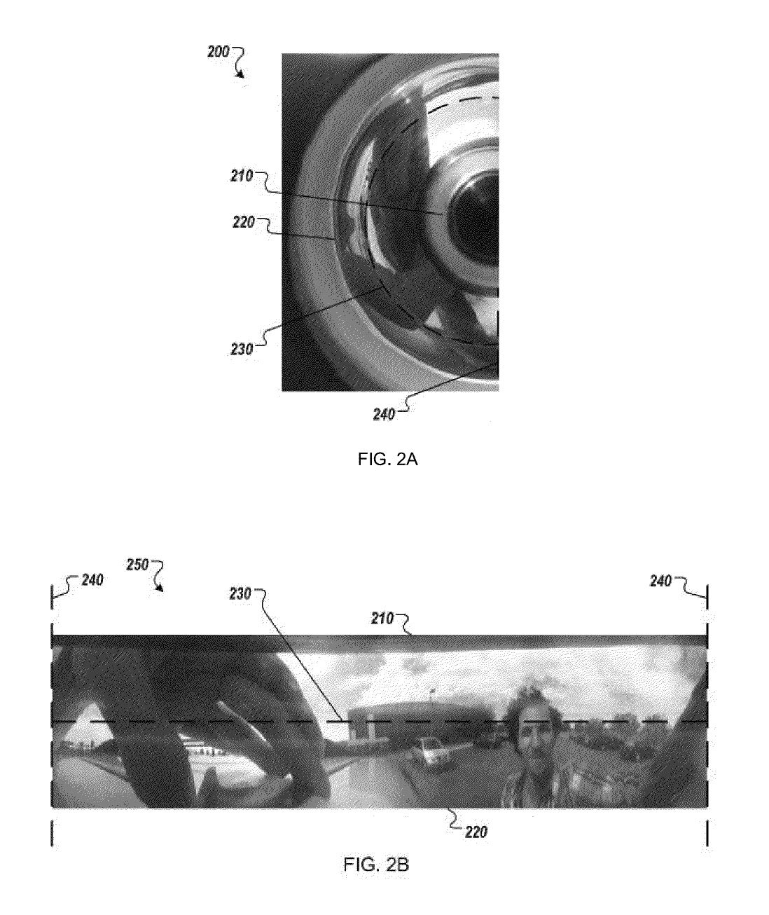

Referring now to FIG. 2A, an example panoramic image 200 captured through an exemplary optical block is illustrated. As depicted in FIG. 2, a panoramic image 200 may be an image provided by an optical block and captured by the second camera 102. In some aspects, the optical block may comprise a panoramic optical block.

In general, the captured panoramic image 200 is a “warped” image as compared to an image perceived by a human via a human ocular system. The panoramic image 200 includes a Panoramic view that is less than 360 degrees, such as for example, in the instance with two cameras a 180 degree view is captured with each camera and in the instance with three cameras, a 120 degree view may be captured and reflected and refracted into an annular image.

The annular image includes a center of a ring that corresponds to one vertical limit 210 of a visible range of the optical block 210 (e.g., the uppermost limit of the range of view of the optical block 210) and an outer edge of a ring that corresponds to another other vertical limit 220 of a visible range of the optical block 210 (e.g., the lowermost limit of the range of view of the optical block 210). A circumference of the annular ring corresponds to a horizontal field of view 230 of the optical block 210.

Referring now to FIG. 2B an example of a “de-warped” panoramic image 250 is illustrated. In the illustrated example, the de-warped panoramic image 250 is a post image capture processed version of the captured panoramic image 200. In general terms, in the de-warped panoramic image, image data included in a ring of the captured panoramic image 200 is split at a boundary 240 and transformed from a ring to a rectangular shape generally bounded by the boundary 240 at two parallel edges, and by the vertical limits 210 and 220 at an opposite pair of edges.

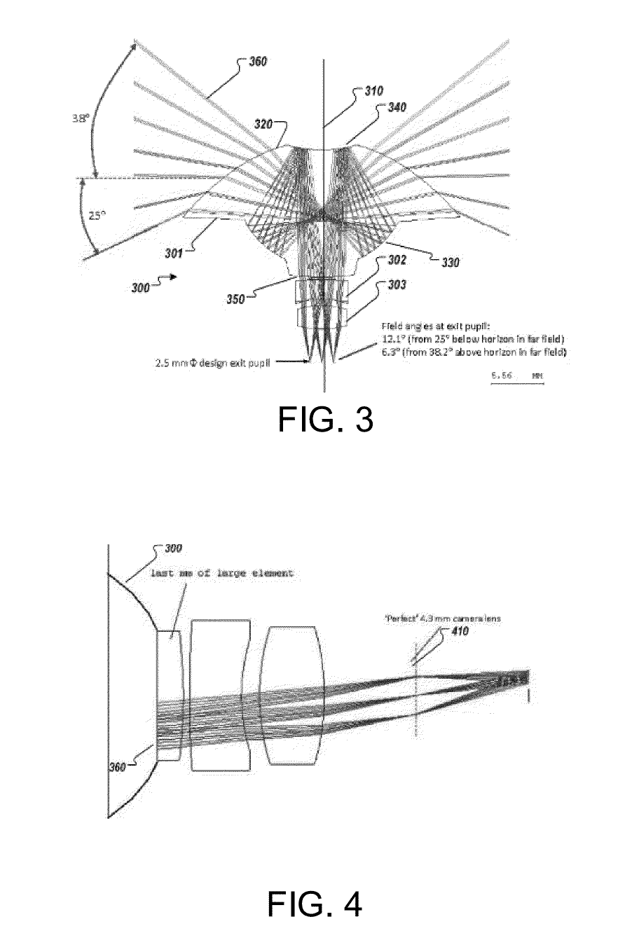

Referring now to FIG. 3, an exemplary imaging lens 300 that includes an element 301, an element 302, and an element 303, all sharing an axis of symmetry 310 is illustrated. The element 301 has a first refractive conic surface 320, a first reflective conic surface 330, a second reflective conic surface 340, and a second refractive conic surface 350. In some embodiments, a diameter of element 301 can be about 28.5 mm, the distance from a camera pupil to a farthest surface on the lens 300 can be about 22.5 mm.

Some embodiments may also include field angles emerging from element 301 which are incident to the camera (e.g., the camera 101 of FIG. 1A) wherein the field angles may be about +/−12.1 degrees maximum and about +/−6.3 degrees minimum. In some embodiments, the field angles may cover a field of view covering about 25 degrees below horizon of the camera to about 38 degrees above horizon of the camera, with a substantially 360 degree azimuth.

In another aspect, in some embodiments, one or more rays of light 360, may enter element 301 at a first refractive conic surface 320 and be refracted to a first reflective conic surface 330. Rays of light 360 may also be reflected onto a second reflective conic surface 340, and in turn be reflected to a second refractive conic surface 350. The rays of light 360 may emerge from the element 301 through the second refractive conic surface 350 and then pass through the elements 302 and 303.

Lenses 302 and 303 may also be included that further refract the rays of light 360. The lenses which further refract the rays of light may be referred to as a “doublet” or a collimator. The doublet may be functional to cause the rays of light 360 to emerge from element 303 in a substantially parallel manner (e.g., the rays substantially do not converge to a focal point), or otherwise referred to as a collimated beam of light.

In some specific implementations, elements 301-303 may be formed of one or both of: acrylic and polycarbonate plastics and may be formed via a molding process. Some embodiments may also include lenses 300 that project a field of view of 360 degrees by approximately 63 degrees onto a two dimensional annular format (e.g., the panoramic image 200 of FIG. 2) coincident with a CCD array, such as a CCD array that may be included in the camera 102 of FIG. 1A.

Accordingly, in some embodiments, lenses 300 may function over an equivalent field angle range of about +/−12.1 degrees maximum and about ±6.3 degrees minimum to cover approximately 25 degrees below to approximately 38 degrees above horizon.

Referring now to FIG. 4, an enlarged view of the lens 300 of FIG. 3 is illustrated. As discussed previously, rays of light 360, emerge from the lens 300 in a substantially parallel manner. The rays are projected onto a lens 410 of the camera 102. The lens 410 may include optics that focus the rays onto a CCD, film, or any other appropriate image receiving apparatus or medium.

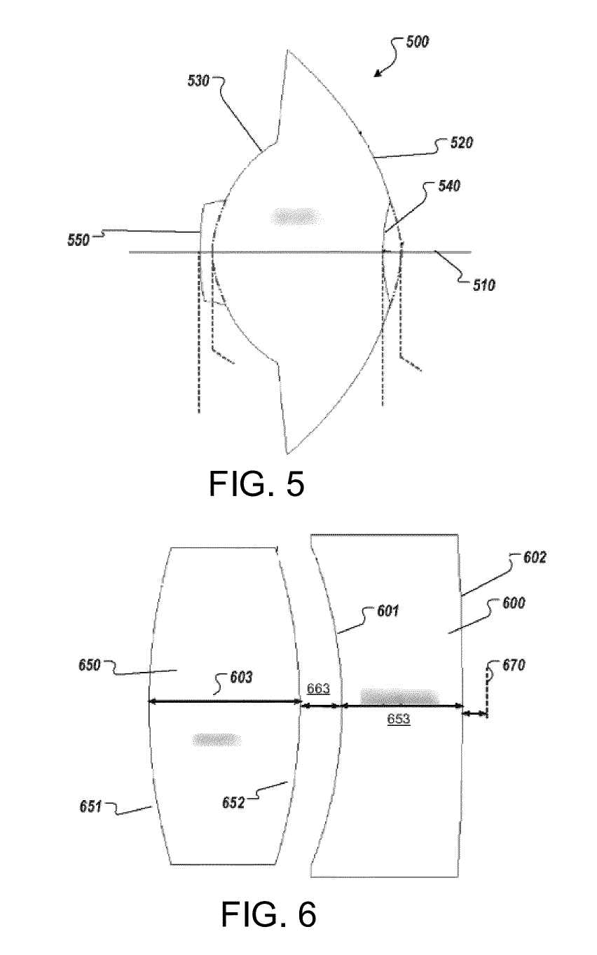

Referring now to FIG. 5, a sectional view of an exemplary lens element 500 is illustrated. In some implementations, element 500 may be one and the same as element 301 of FIG. 3. In some embodiments, element 500 may also be formed of an acrylic material. The element 500 may include a radial form about an axis of symmetry 510.

In some specific embodiments, a first refractive conic surface 520 may include a convex surface with a radius of about −14.05964 mm and a K value of about −0.852225. A first reflective conic surface 530 may include a convex surface with a radius of about 9.54611 mm and a K value of about 0.081569.

Some embodiments may also include a second reflective conic surface 540 including a concave surface with a radius of about 15.70354 mm and a K value of about 10.093278. A second refractive conic surface 550 may include a convex surface with a radius of about 20.0000 mm, a K value of about −1, and an A value of about −0.224068E-03. The second refractive aspheric conic may include a surface 550, which assists to mitigate aberration of the image inherent in refractive and reflective lens designs and helps to provide increased resolution in, for example, high definition panoramic videos and images.

Referring now to FIG. 6 a sectional view of an exemplary lens elements 600 and element 650 is illustrated. In some implementations, lens element 600 may be one and the same as element 302 and element 650 may be one and the same as element 303 of FIG. 3. In some specific embodiments, element 650 may be formed of acrylic, and include a refractive surface 651 and a refractive surface 652. The refractive surface 651 and a refractive surface 652 may be spaced apart by a thickness of approximately 2.5000 mm at a radial axis 603. The surface 651 is convex with a radius of approximately 9.34075 mm and an optimum clear aperture (CA) of about 4.10 mm. Surface 652 may be convex with a radius of approximately −8.66763 mm and a CA of about 4.34 mm.

In some embodiments, element 600 may be formed of polycarbonate or polystyrene, and include two refractive surfaces, refractive surface 601 and refractive surface 602. Refractive surface 601 and refractive surface 602 may be spaced apart by a thickness of approximately 2.0000 mm at a radial axis 653. Refractive surface 601 may be concave with a radius of approximately −7.10895 mm and an optimum clear aperture (CA) of about 4.28 mm. Refractive surface 602 may be convex with a radius of approximately −60.000 mm, a K value of about −1, an A value of about −0.301603E-03, and a CA of about 4.48 mm.

Refractive surfaces 652 and 601 may be separated by a distance of about 0.700 mm at a radial axis 663. Surface 602 may be separated from surface 670 by a distance of about 0.25 mm. In some implementations, the surface 670 can be the surface of a camera lens (e.g., the lens of the camera 102 of FIG. 1A).

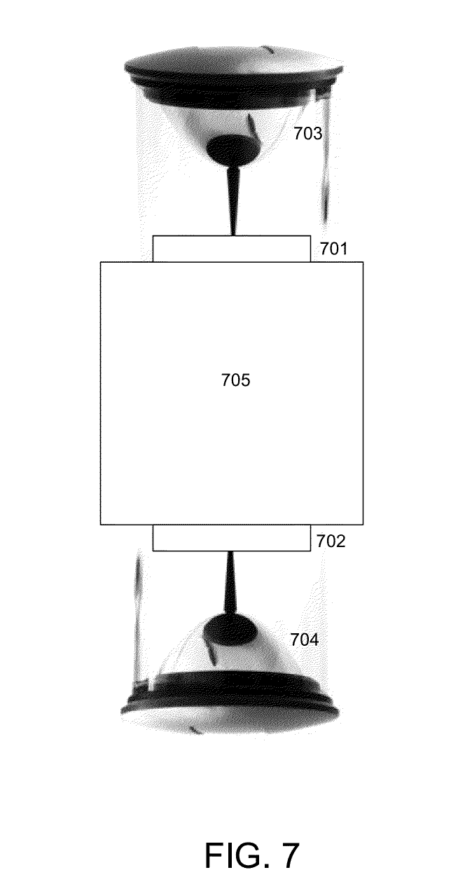

Referring now to FIG. 7, some additional embodiments may include two or more cameras 701-702 facing outward towards respective arcuate reflective surfaces 703-704. In such embodiments, some portion of a panoramic filed may be reflected in the arcuate reflective surfaces 703-704 and a camera 701-702 may capture the image data from reflected by the reflective surfaces 703-704. A processor 705 may process the image data and dewarp and align the data into an image suitable for viewing.

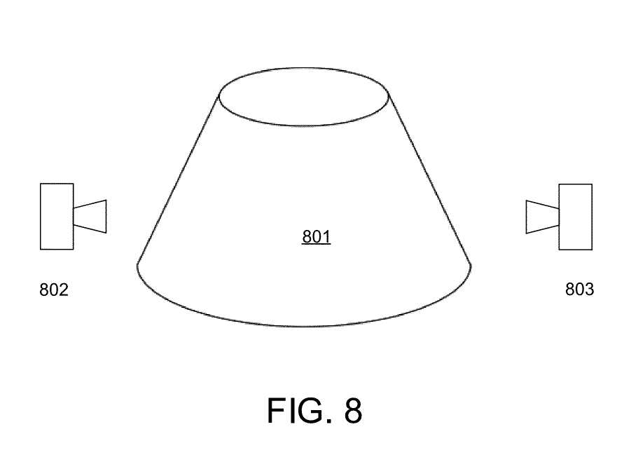

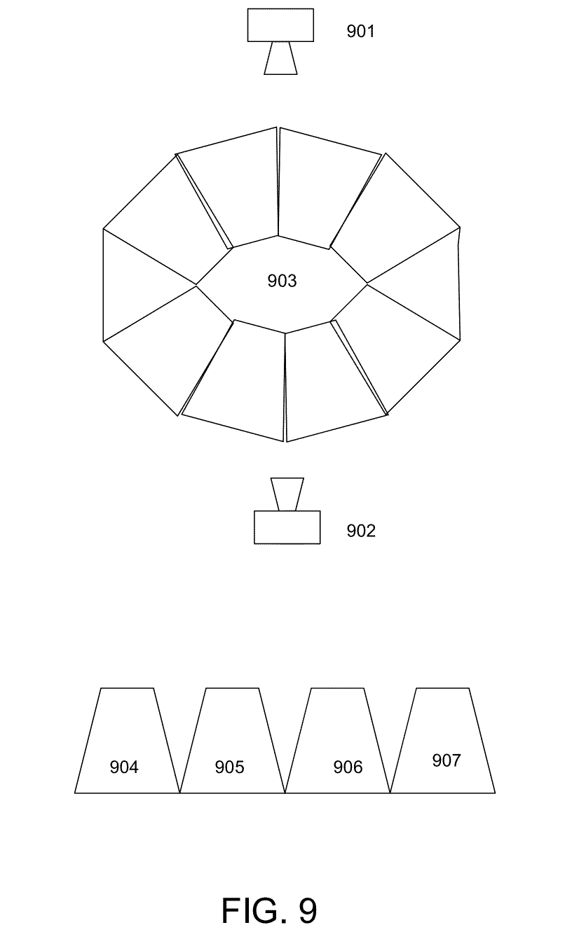

Referring now to FIG. 8, a reflective surface may include various shapes that provide an image with a panoramic view. As illustrated, in some embodiments, a reflective surface 801 may include a frustum or other curved shape that also include provides a perspective such that cameras 802-803 may capture imagery reflected on a reflective surface 801 in the shape of a frustum.

Referring now to FIG. 9, in some additional embodiments, a reflective surface 903 frustum like shape may be comprised of multiple angled surfaces 904-905 arranged to provide a panoramic view of a venue. Cameras 901-902 may capture imagery reflected in the multiple surfaces 904-907 and transmit the captured imagery to be processed.

In some exemplary embodiments, a classroom can be outfitted with multiple camera devices placed at various locations within the classroom, wherein one camera may be positioned to capture a detailed view of a blackboard at the front of the room, while a panoramic camera may be positioned to capture a substantially 360-degree view of the classroom from approximately the instructor's or a student's audio-visual perspective. In some implementations, consumer-grade electronic devices can be used to capture one or more streams of video. For example, a cellular telephone configured for video recording may be used. Furthermore, some of the aforementioned consumer-grade electronic devices can be equipped with lenses that convert the devices' cameras into panoramic cameras. Other types of time-based media capture devices may also be used, such as electronic whiteboards that convert the instructor's writing and drawings into time-based media streams which may be synchronized with video streams. An arbitrary number of audio devices (e.g., microphones) can also be located in various places within the classroom. For example, an instructor can wear a wireless lapel microphone to capture his or her lecture, while another microphone may be directed to capture the sounds of students in the classroom as they participate in classroom discussions.

Simultaneously-captured audio and video (AV) sources may be synchronized and associated together as a group in time and space using information as the physical locations and orientations of the AV capture devices, as well as the degree to which their time-bases are synchronized. The grouped AV streams can then be made available for download or streaming to viewers.

Viewers may receive and view some or all of the grouped AV streams, or parts thereof, based at least partly on the viewer's selections from among the various AV streams in the group, in many cases using a standardized viewer which is appropriate for the specific collection of media types. The set of such viewers is extensible, allowing the system to become adaptive and flexible as it is utilized more frequently by a large collection of users. For example, the grouped AV stream may include information that describes each of the audio, video, and other time-based media streams, including the locations where the respective streams were captured relative to each other. By selecting various AV streams captured from several different audiovisual perspectives, a student may view a recorded classroom lecture from various viewpoints within the classroom. Furthermore, video streams of panoramic video may be transformed to a first-person perspective in response to viewer input. For example, the student may be provided with user interface (UI) controls that allow the user to select a subsection of the panoramic view that is to be “de-warped” into a first-person view, thereby providing the student with a simulated ability to look (e.g., pan) around the classroom.

By providing such a system, sounds and views of an event may be simultaneously captured at a number of locations at an event, and these various audio and video sources can be aligned and grouped with each other for subsequent viewing. Later, viewers can access the grouped AV sources, view the recorded event from any of the available viewpoints, switch among viewpoints, and pan about the recoded event in a manner that can gives the viewer an interactive playback experience that can provide a greater feeling of presence and involvement in the event that the viewer may feel by passively watching a traditional video presentation.

Captured media may include audio, video, and metadata. In some implementations, the metadata may include time codes or timing information. For example, SMPTE time codes may be associated with the media to make it easier to later synchronize or otherwise align the AV media streams. In some implementations, the metadata may identify the media capture device used to capture the media.

In some implementations, the metadata may include positional information that describes the media capture device used to capture the media. For example, the metadata for the AV media stream 107 may indicate that the media capture device captured its AV media at a location near the front of a classroom, while the metadata of the AV media stream 108 may indicate that the media capture device is capturing AV media from a location near the back of the classroom. In some implementations, positional information may be provided manually (e.g., by users of the media capture devices. In some implementations, positional information may be determined by the media capture devices. For example, the media capture devices may include global positioning system (GPS) sensors, electronic compasses, accelerometers, beacons, or other appropriate forms of position locators that may be used by the media capture devices to determine their absolute positions, or to determine the positions of the media capture devices relative to each other.

The AV media streams are received by a computer device and stored in a storage device. The computer device associates and aligns the stored AV media streams and adds a set of metadata. In some implementations, the metadata can include information about, the locations of the media capture devices, information about the media streams (e.g., bitrates, compression formats, panoramic lens parameters), information about the event (e.g., name, date, location, transcripts), embedded electronic content (e.g., electronic documents, links to related content), or other appropriate information.

In some implementations, the alignment may be based on time codes included in the AV media streams. For example, the media capture devices may include high-precision clocks that are substantially synchronized, and these clocks may be used to provide time code metadata. In some implementations, the media capture devices may be triggered to begin capturing the AV media streams 107, 108 at substantially the same time.

In some implementations, beacons may be used to keep the media capture devices synchronized. For example, a periodic radio frequency “heartbeat” signal may be broadcast to re-align the media capture devices' clocks. In another example, infrared (IR) light may be used. For example, CMOS video capture devices are generally sensitive to infrared wavelengths of light that humans cannot see. The media capture device may be equipped with such an IR beacon that is invisible to nearby persons, yet the media capture device 100 may be able to detect the beacon through its camera and use the beacon to synchronize itself with the media capture device,

In another example, acoustic beacons, such as ultrasonic pings that are inaudible to humans may be used. For example, a lecture hall or auditorium may be large enough to permit echoing to occur, therefore an audio stream captured by a microphone at a lectern in the front of the room, and an audio stream captured at the back row of the room, may exhibit an unwanted echo due to the sound propagation delay between the two microphones when played back simultaneously. An audible or ultrasonic acoustic ping may therefore be broadcast from the lectern or elsewhere in the room. Since the propagation delay of the acoustic ping may be substantially equal or proportional to the delay of sounds in the room, the ping may be used to synchronize the media recording devices relative to one another.

In some implementations, the AV media streams may be aligned based on events recorded in the media of the AV media streams. For example, two or more video streams may be analyzed to locate one or more key events within the stream that may have been captured by two or more of the media capture devices. The two or more video or audio streams may then be time shifted to align the key event. Such key events may include visible events such as a sudden change in the level or hue of the recorded ambient lighting, change in the content of the scene (e.g., students jumping up from their chairs at the end of a class period), or other identifiable changes in the scene. Key events may include audible events such as taps of chalk against a chalkboard, coughs or sneezes in a classroom, or other identifiable changes in volume (e.g., applause), frequency (e.g., the notes in a melody), or spectrum (e.g., white noise disappears when a ventilation system shuts off).

In some implementations, video streams may be synchronized substantially absolutely while audio streams may be synchronized relatively. For example, in a large venue, sound and video of a distant subject may appear out of sync (e.g., light may reach the camera perceptibly sooner than the accompanying sound). By synchronizing the audio and video differently, perceived synchronization may be attained.

One general aspect includes a panoramic image capture apparatus including: one or more arcuate reflective surfaces, two or more image capture devices positioned proximate to the one or more reflective surfaces for receiving reflected images reflected off of the reflective surfaces and generating image data based upon the reflected images, and a processor for receiving the image data generated by the two or more image capture devices and providing de-warped image data.

Implementations may include one or more of the following features. The panoramic image capture apparatus where the processor additionally provides metadata associated with the image data. The panoramic image capture apparatus where one or more of the two or more image capture devices includes a charged coupled device camera. The panoramic image capture apparatus may include one or more reflective surfaces including an obloid shape and/or an image capture apparatus where the one or more reflective surfaces includes a spheroid.

Implementations may also include a panoramic image capture apparatus where one or more of the two or more image capture devices includes a charged coupled device that is essentially planar. The panoramic image capture apparatus where optical refractive lenses and optical reflective lenses project an annular image onto the charged coupled device. The panoramic image capture apparatus where at least one of the one or more arcuate reflective surfaces includes a panoramic optical block and where the annular image includes a substantially 360 degree view of an area around the panoramic optical block. The panoramic image capture apparatus where the annular image includes an inner edge of an image ring including a center of the image ring, where the inner edge of the ring corresponds to a first vertical limit of a visible range of the panoramic optical block. The panoramic image capture apparatus where annular image additionally includes an outer edge of the image ring, where the outer edge of the image ring corresponds to an outer vertical limit of a visible range of the panoramic optical block. The panoramic image capture apparatus where at least one of the one or more arcuate reflective surfaces includes a panoramic optical block and where the panoramic optical block further includes relay optics or relay lenses for transferring an intermediate image onto a camera lens included in the camera. The panoramic image capture apparatus where at least one of the one or more arcuate reflective surfaces includes a panoramic optical block and where the panoramic optical block includes an imaging lens including multiple elements, each element including a shared axis of symmetry.

The panoramic image capture apparatus may also include a first element of the multiple elements including the panoramic optical block includes a first refractive conic surface and a first reflective conic surface and/or a panoramic image capture apparatus where a first element of the multiple elements including the panoramic optical block additionally includes a second reflective conic surface and a second refractive conic surface.

In some embodiments, the panoramic image capture apparatus may include a diameter of the first element is about 28.5 mm, and a distance from a camera pupil to a farthest surface on the first element is about 22.5 mm. The panoramic image capture apparatus where field angles emerging from the first element are generally incident to the camera. The panoramic image capture apparatus where the field angles emerging from the first element are about +/−12.1 degrees maximum and about +/−6.3 degrees minimum.

The panoramic image capture apparatus may also include field angles with a field of view including about 25 degrees below a horizon of the camera to about 38 degrees above a horizon of the camera. The panoramic image capture apparatus where the field angles include a substantially 360 degree azimuth. The panoramic image capture apparatus where one or more rays of light may enter the first element at a first refractive conic surface and be refracted to a first reflective conic surface and also be reflected onto a second reflective conic surface and in turn be reflected to a second refractive conic surface and emerge from the first element through a second refractive conic surface. Other embodiments may also be within the scope of the claims.

A number of implementations have been described. Nevertheless, it will be understood that various modifications may be made without departing from the spirit and scope of the disclosure. For example, various forms of the flows shown above may be used, with steps re-ordered, added, or removed. Also, although several applications of the media capture systems and methods have been described, it should be recognized that numerous other applications are contemplated. Accordingly, other implementations are within the scope of the following claims.

What is claimed is:

1. A panoramic image capture apparatus comprising:
one or more arcuate reflective surfaces;
two or more image capture devices positioned proximate to the one or more reflective surfaces for receiving reflected images reflected off of the reflective surfaces and generating image data based upon the reflected images; and
a processor for receiving the image data generated by the two or more image capture devices and providing dewarped image data.

2. The panoramic image capture apparatus of claim 1 wherein the processor additionally provides metadata associated with the image data.

3. The panoramic image capture apparatus of claim 1 wherein one or more of the two or more image capture devices comprises a charged coupled device camera.

4. The panoramic image capture apparatus of claim 1 wherein the one or more reflective surfaces comprises an obloid.

5. The panoramic image capture apparatus of claim 1 wherein the one or more reflective surfaces comprises a spheroid.

6. The panoramic image capture apparatus of claim 1 wherein one or more of the two or more image capture devices comprises a charged coupled device that is essentially planar.

7. The panoramic image capture apparatus of claim 6 wherein optical refractive lenses and optical reflective lenses project an annular image onto the charged coupled device.

8. The panoramic image capture apparatus of claim 7 wherein at least one of the one or more arcuate reflective surfaces comprises a panoramic optical block and wherein the annular image comprises a substantially 360 degree view of an area around the panoramic optical block.

9. The panoramic image capture apparatus of claim 8 wherein the annular image comprises an inner edge of an image ring comprising a center of the image ring, wherein the inner edge of the ring corresponds to a first vertical limit of a visible range of the panoramic optical block.

10. The panoramic image capture apparatus of claim 9 wherein annular image additionally comprises an outer edge of the image ring, wherein the outer edge of the image ring corresponds to an outer vertical limit of a visible range of the panoramic optical block.

11. The panoramic image capture apparatus of claim 1 wherein at least one of the one or more arcuate reflective surfaces comprises a panoramic optical block and wherein the panoramic optical block further comprises relay optics or relay lenses for transferring an intermediate image onto a camera lens included in the camera.

12. The panoramic image capture apparatus of claim 1 wherein at least one of the one or more arcuate reflective surfaces comprises a panoramic optical block and wherein the panoramic optical block comprises an imaging lens comprising multiple elements, each element comprising a shared axis of symmetry.

13. The panoramic image capture apparatus of claim 12 wherein a first element of the multiple elements comprising the panoramic optical block comprises a first refractive conic surface and a first reflective conic surface.

14. The panoramic image capture apparatus of claim 12 wherein a first element of the multiple elements comprising the panoramic optical block additionally comprises a second reflective conic surface and a second refractive conic surface.

15. The panoramic image capture apparatus of claim 14 wherein a diameter of the first element is about 28.5 mm, and a distance from a camera pupil to a farthest surface on the first element is about 22.5 mm.

16. The panoramic image capture apparatus of claim 15, wherein field angles emerging from the first element are generally incident to the camera.

17. The panoramic image capture apparatus of claim 16, wherein the field angles emerging from the first element are about +/−12.1 degrees maximum and about +/−6.3 degrees minimum.

18. The panoramic image capture apparatus of claim 17, wherein the field angles comprise a field of view comprising about 25 degrees below a horizon of the camera to about 38 degrees above a horizon of the camera.

19. The panoramic image capture apparatus of claim 18, wherein the field angles comprise a substantially 360 degree azimuth.

20. The panoramic image capture apparatus of claim 19 wherein one or more rays of light may enter the first element at a first refractive conic surface and be refracted to a first reflective conic surface and also be reflected onto a second reflective conic surface and in turn be reflected to a second refractive conic surface and emerge from the first element through a second refractive conic surface.
